(19) United States
(12) Patent Application Publication
(10) Pub. No.: US 2002/0113869 A1
(43) Pub. Date: Aug. 22, 2002

(54) Pipeline mapping system and method

(76) Inventor: Scott M. Kirkwood, Cape Coral, FL (US)

Correspondence Address: EDWARD M. LIVINGSTON, ESQUIRE, 628 Ellen Drive, P.O. Box 1599, Winter Park, FL, 32790, US

(21) Appl. No.: 09/740,069

(22) Filed: Dec. 18, 2000

(51) Int. Cl. H04N 7/18; H04N 9/47

(52) U.S. Cl. 348/84; 348/135

(57) ABSTRACT

A pipeline mapping system (1) and method has a mapping probe (2) on a probe conveyor (3) that is positioned on a base vehicle (5) in a main pipeline (6) from which the probe conveyor is extendable into a lateral pipeline (4) selectively. The base vehicle has a vehicle motor that can be a vehicle water jet (7) for propulsion of the base vehicle in the main pipeline and the probe conveyor has a probe motor that can be a probe water jet (8) for propulsion of the probe conveyor in the lateral pipeline. A mapping recorder that can include a metal detector (9), a TV monitor (10) and a computer (11) is in electronic communication with the mapping probe for recording mapping information from the mapping probe.

### BACKGROUND OF THE INVENTION

This invention relates to mapping position, structure and condition of main and branch-off lateral sewage and other liquid-conveyance pipelines for maintenance and repair.

Pipeline inspection devices are well-known. Most have TV cameras for remote observance and are propelled through the pipelines with various mechanical linkage, crawler mechanisms or water-nozzle reaction thrusters. However, there are no known pipeline mapping systems and methods as taught by this invention.

Examples of known pipeline inspection devices that are most-closely related but yet different are described in the following patent documents. U.S. Pat. No. 5,956,135, issued to Quesnel on Sep. 21, 1999, described a pipeline-inspection apparatus having a lateral-line probe inserted into a lateral line with a semi-rigid rod that was pushed incrementally with repeated gripping, advancing and releasing of the semi-rigid rod. U.S. Pat. No. 4,991,006, issued to Wood on Feb. 5, 1991, described insertion of a probe camera into lateral pipelines from a main pipeline base with a protrusion from a controllable eversion hose. U.S. Pat. No. 4,985,763, issued to Fraser on Jan. 15, 1991, described a water-jet nozzle for propelling inspection devices in pipelines. U.S. Pat. No. 4,677,472, issued to Wood on Jun. 30, 1987, described a flexible tube advanced by pincher wheels for extending a probe laterally from a pipeline inspection base. U.S. Pat. No. 4,651,558, issued to Martin et al. on Mar. 24, 1987, described a method and apparatus for inspecting lateral lines with an optic probe on a flexible push rod extendible from a launcher into a main pipeline with pinch rollers.

### SUMMARY OF THE INVENTION

Objects of patentable novelty and utility taught by this invention are to provide a pipeline mapping system and method which:

positions a mapping probe selectively in main and lateral pipelines;

communicates mapping information intermediate the mapping probe and a mapping recorder;

removes visual obstruction from internal pipe surfaces as necessary for accurate mapping and inspection;

provides location, condition and structure mapping of the main and lateral pipelines;

provides selectively graphic and video observation and recording; and

is fast, convenient, inexpensive and accurate.

This invention accomplishes these and other objectives with a pipeline mapping system and method having a mapping probe on a probe conveyor that is positioned on a base vehicle from which the probe conveyor is extendable into a lateral pipeline selectively. The base vehicle has a vehicle motor for propulsion of the base vehicle in the main pipeline and the probe conveyor has a probe motor for propulsion of the probe conveyor in the lateral pipeline. A mapping recorder is in electronic communication with the mapping probe for recording mapping information from the mapping probe. A probe light at the probe and a vehicle light at the vehicle aid visibility of mapping information for communication by the probe. A TV camera on the probe can be employed to convey visual observation by the probe to the mapping recorder, to a TV monitor and to a separate recorder selectively. The TV recorder can have an electronic locator for detecting a metallic mass of the mapping probe. The mapping recorder and the main vehicle can have transmitters which transmit mapping information to the TV recorder. The main vehicle can have a TV camera for communication of main-pipeline information, vehicle information and probe information to the TV monitor and to the mapping recorder selectively.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF DRAWINGS

This invention is described by appended claims in relation to description of a preferred embodiment with reference to the following drawings which are explained briefly as follows:

FIG. 1 is a partially cutaway side view of the pipeline-mapping system; and

FIG. 2 is a partially cutaway side view of a mapping probe in a lateral pipeline.

### DESCRIPTION OF PREFERRED EMBODIMENT

Listed numerically below with reference to the drawings are terms used to describe features of this invention. These terms and numbers assigned to them designate the same features throughout this description.

| | |
|---|---|
| 1. Pipeline mapping system | 14. Base emitter |
| 2. Mapping probe | 15. Electronic receiver |
| 3. Probe conveyor | 16. Lateral-pipeline connection |
| 4. Lateral pipeline | 17. Probe light |
| 5. Base vehicle | 18. Probe TV camera |
| 6. Main pipeline | 19. Vehicle light |
| 7. Vehicle water jet | 20. Vehicle TV camera |
| 8. Probe water jet | 21. Sled |
| 9. Metal locator | 22. Probe manipulator |
| 10. TV monitor | 23. Manipulation controls |
| 11. Computer | 24. Probe controller |
| 12. Ground | 25. Water conveyance |
| 13. Probe emitter | 26. Jet streams |

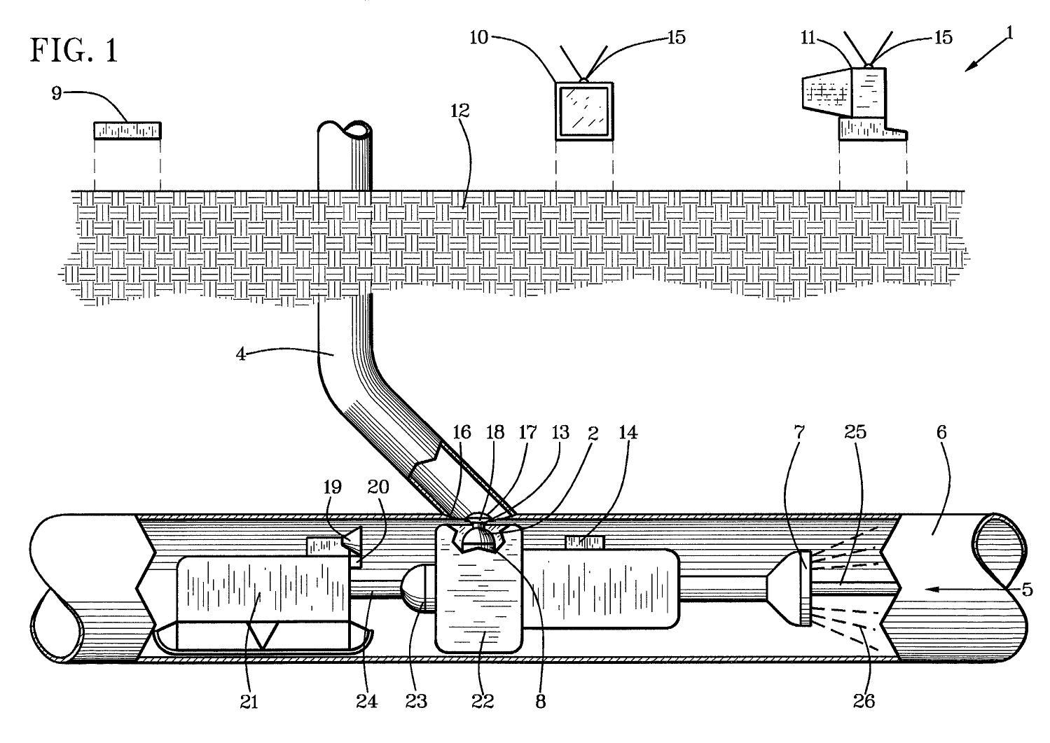

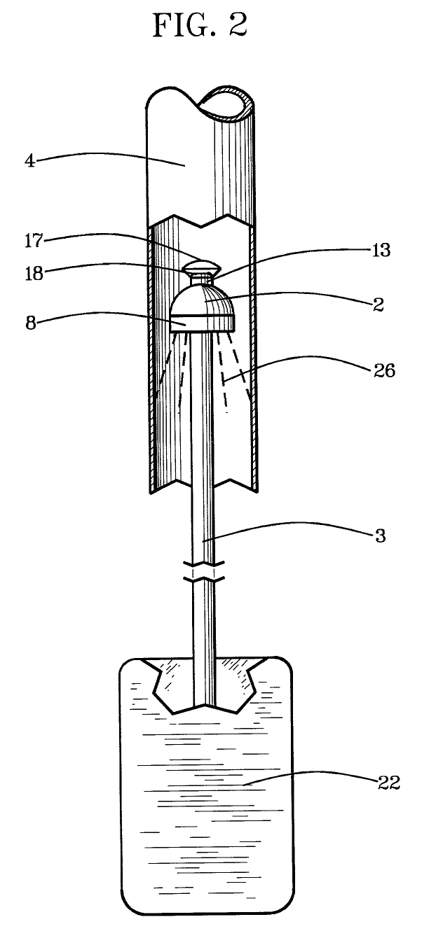

Referring to FIGS. 1-2, a pipeline mapping system 1 has a mapping probe 2 on a probe conveyor 3 that is extendable into a lateral pipeline 4 from a base vehicle in a main pipeline 6. The base vehicle 5 has a vehicle motor that can be a vehicle water jet 7 having jet-nozzle structure for propulsion in the main pipeline 6 selectively. The probe conveyor 3 has a probe motor that can be a probe water jet 8 having jet-nozzle structure for propulsion of the probe conveyor 3 with the mapping probe 2 thereon in the lateral pipeline 4.

A mapping recorder, which can include a metal locator 9, an on-site or selectively positioned TV monitor 10 and a computer 11 having graphics-producing capability for mapping positions of the mapping probe 2 on a graphic map for communication to a computer printer, which is not shown, for computer printout.

The computer 11 also can have graphics-display capability for displaying graphics produced by the computer 11.

The mapping probe 2 can include predetermined metallic mass for location by the metal locator 9 from above ground 12 in which the mapping probe 2 is positioned. The base vehicle 5 also can have or can include predetermined metallic mass for location by the metal detector 9 from above ground 12 in which the base vehicle 5 is positioned.

The mapping probe 2 can have an electronic probe emitter 13 and the base vehicle 5 can have a base emitter 14 for electronic communication to an electronic receiver 15 for marking positions of the mapping probe 2 and of the base vehicle 5 respectively and for recording conditions and structure of the main pipeline 6, the lateral pipeline 4 and lateral-pipeline connections 16.

In close proximity to the probe emitter 13 on the mapping probe 2 are a probe light 17 and a probe TV camera 18 for electronic communication of conditions and structure of the main pipeline 6 when the mapping probe 2 is not in a lateral pipeline 4 and for communication of conditions and structure of the lateral pipeline 4 when the mapping probe 2 is in the lateral pipeline 4.

A vehicle light 19 and a vehicle TV camera 20 are positioned on a portion of the base vehicle 5 that can be a sled 21 for remote viewing and controlling of a probe manipulator 22 from which the probe conveyor 3 is extendable into the lateral pipeline 4 from the base vehicle 5. The probe manipulator 22 has electronic manipulation controls 23 that are operable remotely with a probe controller 24 for controlling activity of the mapping probe 2 selectively in relation to video display on the on-site TV monitor 10.

A water conveyance 25 has an inlet end proximate a motor end of the base vehicle 5 for conveyance of pressured water to the vehicle water jet 7 and to the probe conveyor 3 which can include a water conveyance in fluid communication with the probe water jet 8. Jet streams 26 are shown proximate the vehicle water jet 7 in FIG. 1 and proximate the probe water jet 8 in FIG. 2. Whether or not employed as propulsion motors, the vehicle water jet 7 and the probe water jet 8 can utilize the jet streams 26 for flushing a portion of the lateral pipeline 4 and/or the main pipeline 6 for visually observing their interior conditions and structure clearly from a remote position as appropriate. Other probe motors and vehicle motors with related structure can be employed.

Using this pipeline mapping system 1 includes steps of:

placing the base vehicle 5 containing the mapping probe 2 which includes the probe TV camera 18 and the vehicle TV camera 20 with appropriate lighting from the probe light 17 and the vehicle light 19 in the main pipeline 6;

moving and positioning the base vehicle 5 in the main pipeline 6 selectively;

visually observing interior condition and structure of the main pipeline 6 on the TV monitor 10 while map-survey probing the position and condition of the main pipeline 6 with the mapping probe 2;

communicating position and condition of the main pipeline 6 from the mapping probe 2 to the mapping recorder which can include the metal locator 9, the TV monitor 10 and the computer 11;

detecting at least one lateral-pipeline connection 16 of at least one lateral pipeline 4 to the main pipeline 6;

visually observing interior condition and structure of the lateral-pipeline connection 16 on the TV monitor 10 while map-survey probing position and condition of the lateral-pipeline connection 16 with the mapping probe 2;

communicating position and condition of the lateral-pipeline connection 16 from the mapping probe 2 to the mapping recorder which can include the metal locator 9, the on-site TV monitor 10 and the computer 11;

inserting the probe conveyor 3 and the mapping probe 2 into the lateral pipeline 4 selectively;

visually observing interior condition and structure of the lateral pipeline 4 on the TV monitor 10 while probing position and interior condition of the lateral pipeline 4 with preferably the computer 11 of the mapping probe;

communicating position and condition, including any leaks or damage of the lateral pipeline 4 from the mapping probe 2 to preferably the computer 11 of the mapping recorder; and

mapping the condition, physical structure and location of the main pipeline 6 and of the lateral pipeline 4 with the mapping recorder.

A new and useful pipeline mapping system and method having been described, all such foreseeable modifications, adaptations, substitutions of equivalents, mathematical possibilities of combinations of parts, pluralities of parts, applications and forms thereof as described by the following claims and not precluded by prior art are included in this invention.

What is claimed is:

1. A pipeline mapping system comprising:
a mapping probe on a probe conveyor that is extendable into a lateral pipeline from a base vehicle in a main pipeline;
the base vehicle has a vehicle motor for propulsion of the base vehicle in the main pipeline selectively;
the probe conveyor has a probe motor for propulsion of the probe conveyor with the mapping probe thereon in the lateral pipeline; and
a mapping recorder in electronic communication with the mapping probe from a predetermined remote position for recording predetermined mapping information from the mapping probe.

2. The pipeline mapping system of claim 1 wherein:
the mapping probe includes predetermined metallic mass; and
the mapping recorder includes a predetermined metal locator for marking position of the mapping probe from above ground in which the mapping probe is positioned.

3. The pipeline mapping system of claim 1 wherein:
the base vehicle includes predetermined metallic mass; and
the mapping recorder includes a predetermined metal locator for marking position of the base vehicle from above ground in which the base vehicle is positioned.

4. The pipeline mapping system of claim 1 wherein:
the mapping probe includes a predetermined electronic emitter; and
the mapping recorder includes a predetermined electronic probe receiver for marking position of the mapping probe from above ground in which the mapping probe is positioned.

5. The pipeline mapping system of claim 1 wherein:
the base vehicle includes a predetermined electronic vehicle emitter; and
the mapping recorder includes a predetermined electronic receiver for marking position of the base vehicle from above ground in which the base vehicle is positioned.

6. The pipeline mapping system of claim 1 wherein:
the mapping recorder includes a computer having graphics-producing capability for mapping positions of the mapping probe on a graphic map for communication to a computer printer for computer printout.

7. The pipeline mapping system of claim 6 wherein:
the mapping recorder includes a computer monitor having graphics-display capability for displaying graphics produced by the computer.

8. The pipeline mapping system of claim 1 wherein:
the mapping probe includes a probe TV camera with appropriate lighting for video transmission of physical conditions and structure of the main pipeline and the lateral pipeline.

9. The pipeline mapping system of claim 8 wherein:
the mapping recorder includes an on-site TV monitor for displaying the physical conditions and structure of the main pipeline and the lateral pipeline.

10. The pipeline mapping system of claim 1 wherein:
the base vehicle includes a base TV camera with appropriate lighting for aiding video transmission of physical conditions and structure of the main pipeline and the lateral pipeline in addition to video transmission of the mapping probe.

11. The pipeline mapping system of claim 10 wherein:
the mapping recorder includes an on-site TV monitor for displaying the physical conditions and structure of the main pipeline and the lateral pipeline in addition to the mapping probe.

12. The pipeline mapping system of claim 1 wherein:
the base vehicle includes a probe manipulator from which the probe conveyor is extendable into the lateral pipeline from the base vehicle.

13. The pipeline mapping system of claim 12 wherein:
the base vehicle includes a TV camera with appropriate lighting for video aiding transmission of physical conditions and structure of the main pipeline and the lateral pipeline in addition to video transmission of the mapping probe;
the mapping recorder includes an on-site TV monitor for displaying the physical conditions and structure of the main pipeline and the lateral pipeline in addition to the mapping probe; and
the probe manipulator has electronic manipulation controls that are operable remotely with a probe controller for controlling activity of the mapping probe selectively in relation to video display on the on-site TV monitor.

14. The pipeline mapping system of claim 1 wherein:
the vehicle motor includes a vehicle water jet to which pressurized water is supplied from a water conveyance having an inlet end proximate a motor end of the base vehicle.

15. The pipeline mapping system of claim 14 wherein:
the vehicle water jet has jet-nozzle structure and position to dislodge visual obstruction from internal periphery of the main pipeline.

16. The pipeline mapping system of claim 1 wherein:
the probe motor includes a probe water jet to which pressurized water is supplied from a water conveyance having an inlet end proximate the motor end of the base vehicle.

17. The pipeline mapping system of claim 16 wherein:
the probe water jet has jet-nozzle structure and position to dislodge visual obstruction from internal periphery of the lateral pipeline.

18. A pipeline mapping system comprising:
a mapping probe on a probe conveyor that is extendable into a lateral pipeline from a base vehicle in a main pipeline;
the base vehicle has a vehicle motor for propulsion of the base vehicle in the main pipeline selectively;
the prove conveyor has a probe motor for propulsion of the probe conveyor with the mapping probe thereon in the lateral pipeline;
a mapping recorder in electronic communication with the mapping probe from a predetermined remote position for recording predetermined mapping information from the mapping probe;
the mapping probe includes a predetermined metallic mass;
the mapping recorder includes a predetermined metal locator for marking position of the mapping probe from above ground in which the mapping probe is positioned;
the base vehicle includes a predetermined metallic mass;
the mapping recorder includes a predetermined metal locator for marking position of the base vehicle from above ground in which the base vehicle is positioned;
the mapping probe includes a predetermined electronic emitter;
the mapping recorder includes a predetermined electronic receiver for marking position of the mapping probe from above ground in which the mapping probe is positioned;
the base vehicle includes a predetermined electronic emitter;
the mapping recorder includes a predetermined electronic receiver for marking position of the base vehicle from above ground in which the base vehicle is positioned;
the mapping recorder includes a computer having graphics-producing capability for mapping positions of the mapping probe on a graphic map for communication to a computer printer for computer printout;
the mapping recorder includes a computer monitor having graphics-display capability for displaying graphics produced by the computer.
the mapping probe includes a TV camera with appropriate lighting for video transmission of physical conditions and structure of the main pipeline and the lateral pipeline;
the mapping recorder includes an on-site TV monitor for displaying the physical conditions and structure of the main pipeline and the lateral pipeline;
the base vehicle includes a TV camera with appropriate lighting for video transmission of physical conditions and structure of the main pipeline and the lateral pipeline in addition to video transmission of the mapping probe;
the mapping recorder includes an on-site TV monitor for displaying the physical conditions and structure of the main pipeline and the lateral pipeline in addition to the mapping probe;
the base vehicle includes a probe manipulator from which the probe conveyor is extendable into the lateral pipeline from the base vehicle;
the base vehicle includes a TV camera with appropriate lighting for video transmission of physical conditions and structure of the main pipeline and the lateral pipeline in addition to video transmission of the mapping probe;
the mapping recorder includes an on-site TV monitor for displaying the physical conditions and structure of the main pipeline and the lateral pipeline in addition to the mapping probe; and
the probe manipulator has electronic manipulation controls that are operable remotely with a probe controller for controlling activity of the mapping probe selectively in relation to video display on the on-site TV monitor.

19. The pipeline mapping system of claim 18 wherein:
the vehicle motor includes a vehicle water jet to which pressurized water is supplied from a water conveyance having an inlet end proximate a motor end of the base vehicle; and
the vehicle water jet has jet-nozzle structure and position to dislodge visual obstruction from internal periphery of the main pipeline.

20. The pipeline mapping system of claim 18 wherein:
the probe motor includes a probe water jet to which pressurized water is supplied from a water conveyance having an inlet end proximate the motor end of the base vehicle; and
the probe water jet has jet-nozzle structure and position to dislodge visual obstruction from internal periphery of the lateral pipeline.

21. A method for using a pipeline mapping system having a mapping probe on a probe conveyor that is extendable into a lateral pipeline from a base vehicle in a main pipeline; the base vehicle has a vehicle motor for propulsion of the base vehicle in the main pipeline selectively; the probe conveyor has a probe motor for propulsion of the probe conveyor with the mapping probe thereon in the lateral pipeline; and a mapping recorder in electronic communication with the mapping probe from a predetermined remote position for recording predetermined mapping information from the mapping probe;
the method comprising the following steps:
placing the base vehicle containing the mapping probe on the probe conveyor in the main pipeline;
moving and positioning the base vehicle in the main pipeline selectively;
probing position and condition of the main pipeline;
communicating position and condition of the main pipeline from the mapping probe to the mapping recorder;
detecting at least one lateral-pipeline connection of at least one lateral pipeline to the main pipeline.
communicating position and condition of the lateral-pipeline connection from the mapping probe to the mapping recorder; inserting the probe conveyor and the probe into the lateral pipeline selectively; probing position and condition of the lateral pipeline;
communicating position and condition of the lateral pipeline from the mapping probe to the mapping recorder; and
mapping the condition and the location of the main pipeline and of the lateral pipeline with the mapping recorder.

22. A method for using a pipeline-mapping system having:
a mapping probe on a probe conveyor that is extendable into a lateral pipeline from a base vehicle in a main pipeline; the base vehicle has a vehicle motor for propulsion of the base vehicle in the main pipeline selectively; the prove conveyor has a probe motor for propulsion of the probe conveyor with the mapping probe thereon in the lateral pipeline; a mapping recorder in electronic communication with the mapping probe from a predetermined remote position for recording predetermined mapping information from the mapping probe; the mapping probe includes a predetermined metallic mass; the mapping recorder includes a predetermined metal locator for marking position of the mapping probe from above ground in which the mapping probe is positioned; the base vehicle includes a predetermined metallic mass; the mapping recorder includes a predetermined metal locator for marking position of the base vehicle from above ground in which the base vehicle is positioned; the mapping probe includes a predetermined electronic emitter; the mapping recorder includes a predetermined electronic receiver for marking position of the mapping probe from above ground in which the mapping probe is positioned; the base vehicle includes a predetermined electronic emitter; the mapping recorder includes a predetermined electronic receiver for marking position of the base vehicle from above ground in which the base vehicle is positioned; the mapping recorder includes a computer having graphics-producing capability for mapping positions of the mapping probe on a graphic map for communication to a computer printer for computer printout; the mapping recorder includes a computer monitor having graphics-display capability for displaying graphics produced by the computer; the mapping probe includes a TV camera with appropriate lighting for video transmission of physical conditions and structure of the main pipeline and the lateral pipeline; the mapping recorder includes an on-site TV monitor for displaying the physical conditions and structure of the main pipeline and the lateral pipeline; the base vehicle includes a TV camera with appropriate lighting for video transmission of physical conditions and structure of the main pipeline and the lateral pipeline in addition to video transmission the mapping probe; the mapping recorder includes an on-site TV monitor for displaying the physical conditions and structure of the main pipeline and the lateral pipeline in addition to the mapping probe; the base vehicle includes a probe manipulator from which the probe conveyor is extendable into the lateral pipeline from the base vehicle; the base vehicle includes a TV camera with appropriate lighting for aiding video transmission of physical conditions and structure of the main pipeline and the lateral pipeline in addition to video transmission of the mapping probe; the mapping recorder includes an on-site TV monitor for displaying the physical conditions and structure of the main pipeline and the lateral pipeline in addition to the mapping probe; and the probe manipulator has electronic manipulation controls that are operable remotely with a probe controller for controlling activity of the mapping probe selectively in relation to video display on the on-site TV monitor;
the method comprising the following steps:
placing the base vehicle containing the mapping probe which includes the TV camera and appropriate lighting on the probe conveyor in the main pipeline;
moving and positioning the base vehicle in the main pipeline selectively;
visually observing interior condition and structure of the main pipeline on the TV monitor while map-survey probing position and condition of the main pipeline with the mapping probe;
communicating position and condition of the main pipeline from the mapping probe to the mapping recorder;
detecting at least one lateral-pipeline connection of at least one lateral pipeline to the main pipeline;
visually observing interior condition and structure of the lateral-pipeline connection on the TV monitor while map-survey probing position and condition of the lateral-pipeline connection with the mapping probe;
communicating position and condition of the lateral-pipeline connection from the mapping probe to the mapping recorder;
inserting the probe conveyor and the probe into the lateral pipeline selectively;
visually observing interior condition and structure of the lateral pipeline on the TV monitor while probing position and interior condition of the lateral pipeline with the mapping probe;
communicating position and condition of the lateral pipeline from the mapping probe to the mapping recorder; and
mapping the condition, physical structure and location of the main pipeline and of the lateral pipeline with the mapping recorder selectively.

23. The method of claim 22 wherein:
the vehicle motor includes a vehicle water jet to which pressurized water is supplied from a water conveyance having an inlet end proximate a motor end of the base vehicle; and the vehicle water jet has jet-nozzle structure and position to dislodge visual obstruction from internal periphery of the main pipeline; and
comprising the additional step of:
selectively flushing a portion of the main pipeline before visually observing interior condition and structure of the main pipeline and the lateral-pipeline connection on the TV monitor.

24. The method of claim 22 wherein:
the probe motor includes a probe water jet to which pressurized water is supplied from a water conveyance having an inlet end proximate a motor end of the base vehicle; and the probe water jet has jet-nozzle structure and position to dislodge visual obstruction from internal periphery of the lateral pipeline; and
comprising the additional step of:
selectively flushing a portion of the lateral pipeline before visually observing interior condition and structure of the lateral pipeline.
